(19) United States
(12) Patent Application Publication
(10) Pub. No.: US 2012/0173221 A1
(43) Pub. Date: Jul. 5, 2012

(54) Emulation of an Automation System

(76) Inventors: Claudia Lodes, Hirschaid (DE); Christian Spiska, Mohrendorf (DE); Marco Wangerow, Igensdorf (DE)

(21) Appl. No.: 13/380,782

(22) PCT Filed: May 17, 2010
(86) PCT No.: PCT/EP10/56689

§ 371 Date: Dec. 23, 2011

(30) Foreign Application Priority Data
Jun. 26, 2009 (DE) 10 2009 030 842.3

(51) Int. Cl. G06G 7/66

(52) U.S. Cl. 703/20

(57) ABSTRACT

An emulator, a system, and a method for emulating at least one controller of at least one technical facility, wherein an emulator is extended by at least one simulation of an operating system functionality and by a simulation of at least one system functional building block of the controller for high-availability communication to specify an emulation solution which is able to communicate with high reliability with real components from the automation environment through at least one network card and/or a communications processor and at least one communications layer for producing the high-availability communication. The system is networked with the technical facility following the loading of a facility configuration.

### CROSS-REFERENCE TO RELATED APPLICATIONS

This is a U.S. national stage of application No. PCT/EP2010/056689 filed 17 May 2010. Priority is claimed on German Application No. 10 2009 030 842.3 filed 26 Jun. 2009, the content of which is incorporated herein by reference in its entirety.

### BACKGROUND OF THE INVENTION

1. Field of the Invention

The invention relates to simulators and, more particularly, to an emulator, a system and a method for emulating at least one controller of at least one technical facility.

2. Description of the Related Art

Emulations are used in the field of automation technology or systems engineering. In this environment, a simulation of the automation technology is typically employed for training and testing purposes for reasons of cost. In such cases, the controller component, e.g., a programmable logic controller or PLC, is implemented in the form of an emulation (as a “SoftPLC”). Emulation is the simulation of the process control technology that is true to the original and based on a standard PC. In the process, every effort is made to interpret the original automation program as far as possible. The interfaces to the environment are adapted only when necessary. The objective of the emulation solution is to achieve a simulation that is as true as possible to the original, with the least possible distortion due to adaptations of the facility configuration to the emulation system.

In particular application situations, it is necessary to establish a coupling between emulated and real hardware. Until now, however, it has not been possible to incorporate the automation devices running in the emulation for the high-availability coupling with real hardware in a transparent manner in the original network configuration. Since the emulation is currently not capable of communicating in a highly available manner with real components from the automation environment, no coupling is possible.

### SUMMARY OF THE INVENTION

It is therefore an object of the invention to provide an emulation solution that is capable of high-availability communication with real components from the automation environment.

This and other objects and advantages are achieved in accordance with the invention by an emulator for emulating at least one controller of at least one technical facility when the emulator runs on a computer unit of a system according to the invention, where the emulator comprises at least one simulation of an operating system functionality of the controller for high-availability communication and a simulation of at least one system function module of the controller for the high-availability communication, and by a computer program product having an emulator of said type.

The object is further achieved by a system for emulating at least one controller of at least one technical facility, comprising at least one computer unit having at least one input device and at least one output device, at least one emulator according to the invention, at least one network card and/or a communications processor and at least one communication layer for establishing the high-availability communication.

Lastly, the object is achieved by a method for emulating at least one controller of at least one technical facility, where a configuration of the technical facility is performed, the facility configuration is loaded into the computer unit of a system according to the invention and the system is networked with the technical facility via at least one network card and/or a communications processor.

In the emulation solutions in accordance with the prior art, the operating system functionalities necessary for high-availability communication are not implemented in the emulation. For this reason, it has not been possible to implement the communication modules that handle the high-availability communication. Consequently, the conventional emulation solutions that use a network protocol lacking high availability cannot be networked with the automation system that uses a high-availability protocol, due to the protocol layers being incompatible.

By extending the SoftPLC, i.e., the emulator, as an originally pure code interpreter with the parts of the operating system functionalities that are responsible for handling the high availability communication services and by simulating at least one system function module as an interface between the automation program that is to be emulated and the high availability operating system functionalities of the communication services it is now possible to implement a high availability coupling between emulated and real automation technologies.

The emulation solutions in accordance with the invention therefore consists in extending an originally pure code interpreter by the simulation of the operating system functionalities for high-availability communication to train the interpreter for the purpose of handling high-availability communication services that are true to the original.

Furthermore, at least one “original” system function module of the real controller that is responsible for the high availability communication is simulated to ensure the execution of the unchanged automation program using the simulated operating system functionality within the emulation.

In order to emulate the control of the technical facility, a configuration of the facility must also be loaded into the computer unit of the system according to the invention. In addition to the set up and configuration of the emulation environment, the system must be interconnected via at least one network card and/or a communications processor (CP or also NIC (Network Interface Card)) with the real hardware of the technical facility.

In an advantageous embodiment, the simulation of the at least one system function module is implemented as a high-level language module. By using the HLL or high-level language implementation, the integration into the operating system simulation of the SoftPLC can be particularly easily achieved.

In a further advantageous embodiment, the communication layer has a programming interface for establishing at least high-availability connections to devices of the technical facility and a link layer for parameterizing and initializing the connections. In this scheme, the lowest layer, for example, comprises the programming interface of the widespread product “Simatic Net”, on top of which the link layer runs and which has, inter alia, the task of parameterizing all the connections—for example, according to a configuration file—and of initializing the connections for communication.

In a further advantageous embodiment, the facility configuration is loaded into the computer unit by a configuration system. A configuration system of this type is usually also used for installing the configuration on the real part of the automation system, with the result that no additional overhead is incurred owing to the use of the same configuration tool for loading the configuration onto the emulated part of the automation system.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will now be described in greater detail and explained with reference to the exemplary embodiment illustrated in the drawing, in which:

FIG. 1 is a schematic block diagram of the emulation solution in accordance with the invention; and

FIG. 2 is a flow chart of the method in accordance with an embodiment of the invention.

### DETAILED DESCRIPTION OF THE PREFERRED EMBODIMENTS

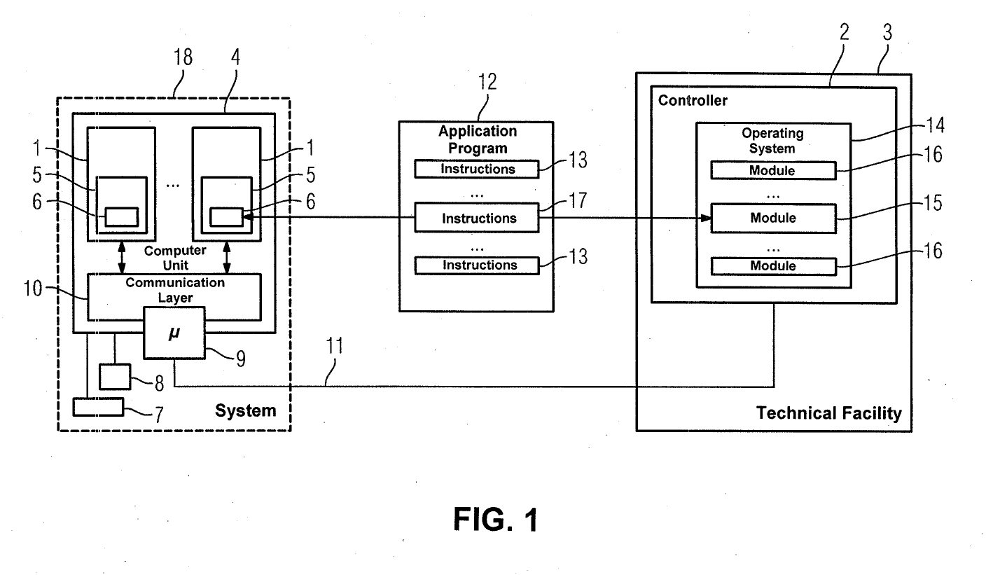

FIG. 1 shows a schematic representation of a system 18 in accordance with the invention, consisting of an input device 7 and an output device 8, and a computer unit 4 having a network card or a communications processor 9 and a communication layer 10. In the example shown, two emulators 1 are installed on the computer unit 4, both of which are able to communicate via the communication layer 10 with a controller 2 of a technical facility 3. Further automation devices of the facility 3 are not shown for clarity of illustration reasons.

The controller 2 embodied as a PLC has an operating system 14 in which various system function modules 15, 16 are implemented. In this case, the function module 15 is responsible for the high-availability communication.

Present in the (respective) emulator 1 (of the SoftPLC) is a simulation 5 of that operating system functionality of the controller 2 that is responsible for the high-availability communication, as well as a simulation 6 of the relevant system function module 15 which is implemented as a high-level language (HLL) module.

A facility configuration is performed for the technical facility 3 and is first installed in a configuration system of the automation environment and is loaded with the aid of the configuration system both onto the real part 2 and onto the emulated part 1 of the automation system. Following the self-evident setting up and configuration of the emulation environment 18 and the setup and networking of the real hardware 3, the emulation system 18 is networked with the technical facility 3—in the example shown, to the PLC 2 of the technical facility 3—via a connection 11 that is suitable for high-availability communication.

An application program 12 (e.g., an automation program) runs on the controller 2 and the emulator 1, with various instructions 13, 17 being processed in sequence. A high-availability communication is invoked in instruction 17, as a result of which the corresponding system function module 15 of the controller 2 or the corresponding simulation 6 in the emulator 1 are activated. When the application program 12 executes in the emulator 1 in accordance with the invention, a high-availability communication with devices in the technical facility 3 is thus also possible via the connection 11, such that a high-availability coupling is realized between emulated and real automation technology.

The disclosed embodiments of the invention relate to an emulator, a system and a method for emulating at least one controller of at least one technical facility. In order to disclose an emulation solution which is able to communicate with high availability with real components from the automation environment, an emulator is enhanced with at least one simulation of an operating system functionality and with a simulation of at least one system function module of the controller for high-availability communication. By at least one network card and/or a communications processor and at least one communication layer for establishing the high-availability communication, the system is networked with the technical facility following the loading of a facility configuration.

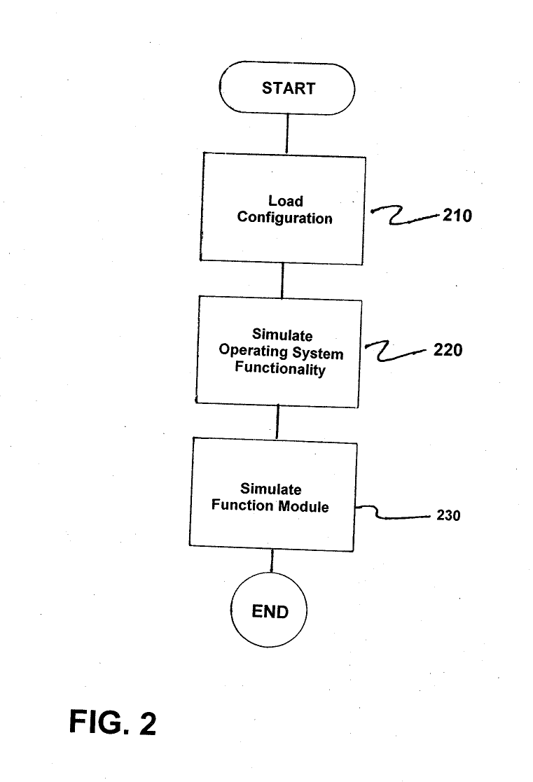

FIG. 2 is flowchart of a method for emulating at least one controller of at least one technical facility. The method comprises loading a configuration of the at least one technical facility into a computer unit of a system for emulating at least one controller of the at least one technical facility, the system being networked with the at least one technical facility through at least one of a network card and a communications processor as indicated in step 210. An operating system functionality of the at least one controller for high-availability communication is simulated by an emulator, as indicated in step 220. The emulator simulates at least one system function module of the controller for the high-availability communication, as indicated in step 230.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-7. (canceled)

8. A system for emulating at least one controller of at least one technical facility, the system comprising:
at least one computer unit having at least one input device and at least one output device;
at least one emulator comprising a simulation of an operating system functionality of the at least one controller for high-availability communication and a simulation of at least one system function module of the controller for the high-availability communication;
at least one of a network card and a communications processor; and
at least one communication layer configured to establish the high-availability communication.

9. The system as claimed in claim 8, wherein the communication layer includes a programming interface for establishing at least high-availability connections to devices of the technical facility and a link layer for parameterizing and initializing the connections.

10. An emulator for emulating at least one controller of at least one technical facility when said emulator executes on a computer unit of a system configured to emulate at least one controller of at least one technical facility, the emulator comprising:
at least one simulation of an operating system functionality of the at least one controller for high-availability communication; and
a simulation of at least one system function module of the controller for the high-availability communication.

11. The emulator as claimed in claim 10, wherein the simulation of the at least one system function module comprises a high-level language module.

12. A non-transitory computer program product having an emulator executing on a processor and encoded with a computer program, which when used on a computer unit of a system configured to emulate at least one controller of at least one technical facility causes the emulator to emulate at least one controller of at least one technical facility,
program code for loading a configuration of the at least one technical facility into a computer unit of a system for emulating at least one controller of the at least one technical facility, the system being networked with the at least one technical facility through at least one of a network card and a communications processor;
program code for simulating of an operating system functionality of the at least one controller for high-availability communication; and
program code for simulating of at least one system function module of the controller for the high-availability communication.

13. A method for emulating at least one controller of at least one technical facility, comprising:
loading a configuration of the at least one technical facility into a computer unit of a system for emulating at least one controller of the at least one technical facility, the system being networked with the at least one technical facility through at least one of a network card and a communications processor;
simulating, by an emulator of the system, an operating system functionality of the at least one controller for high-availability communication; and
simulating, by the emulator, at least one system function module of the controller for the high-availability communication.

14. The method as claimed in claim 13, wherein the configuration of the at least one technical facility is loaded into the computer unit by a configuration system.
